(19) United States
(12) Patent Application Publication
(10) Pub. No.: US 2002/0189914 A1
(43) Pub. Date: Dec. 19, 2002

(54) Plate valve with spring washer for damper

(76) Inventors: Mark R. Naples, Dayton, OH (US); Lisa M. Ott, Loveland, OH (US); Randy L. Hofmann, Centerville, OH (US); John Michael Sarley, Mason, OH (US)

Correspondence Address: ROBERT M. SIGLER, DELPHI TECHNOLOGIES, INC., Mail Code: 480-410-202, P.O. Box 5052, Troy, MI, 48007-5052, US

(21) Appl. No.: 10/155,247

(22) Filed: May 24, 2002

Related U.S. Application Data
(63) Continuation-in-part of application No. 09/481,110, filed on Jan. 11, 2000, now abandoned.
(63) Continuation-in-part of application No. 09/829,444, filed on Apr. 9, 2001, now Pat. No. 6,422,361.

(51) Int. Cl. F16F 9/34

(52) U.S. Cl. 188/322.15

(57) ABSTRACT

A valve for use in a vehicle damper provides a predictable, repeatable clamping force without requiring close tolerancing of parts. The valve includes a valve body having a compression orifice and a rebound orifice extending therethrough. The valve assembly further includes a rebound disk located adjacent the first surface and covering the rebound orifice, and a compression disk located adjacent the second surface and covering the compression orifice. The valve includes a fastener having a head and a shaft extending through the valve assembly, the fastener holding the valve body, the rebound disk and the compression disk in close engagement such that when the valve assembly is immersed in fluid, fluid can be forced through the compression orifice when the pressure of the fluid urges the compression disk away from the compression orifice and fluid can be forced through the rebound orifice when the pressure of the fluid urges the rebound disk away from the rebound orifice. The valve further includes a spring washer located between the head of the fastener and the valve assembly. In one embodiment, the valve assembly is retained between a longitudinal stop and a riveted end of a damper piston rod.

### RELATED APPLICATIONS

This is a Continuation-in-Part of U.S. Ser. No. 09/481,110, filed Jan. 11, 2000 and U.S. Ser. No. 09/829,444, filed Apr. 9, 2001.

### TECHNICAL FIELD

The present invention is directed to a valve for use in a damper.

### BACKGROUND OF THE INVENTION

Shocks, struts, and other damping devices are used in shock absorbing systems of vehicles to dissipate vibrational and other forces sustained by the wheel assemblies of such vehicles. Such damping devices typically operate by transmitting the applied forces to a rod and piston combination that is slidably mounted in an inner, fluid-filled tube of the damper. As the piston is urged through the inner tube by the applied forces, the fluid in the tube is forced through a valve assembly in the piston. The movement of the piston is damped by the resistance to fluid flow through the valve in the piston in a known manner so that the vibrational forces transmitted to the associated vehicle are minimized.

The valve assembly in the piston of such a damping device typically allows fluid to flow through the piston when the fluid on one side of the piston reaches a predetermined pressure relative to the fluid on the other side of the piston. One type of valve assembly in the piston is a “plate valve” which includes a valve body having a plurality of holes and a pair of plates or disks located on either side of the body to cover the holes. The disks typically are clamped against the valve body by a fastener, such as a rivet. Parts of the disks are deflected away from the holes in the valve body to allow fluid to flow through the valve body when the pressure differential of the fluid in the inner tube reaches a predetermined level.

The force with which the disks are clamped against the valve body largely determines the performance characteristics of the damper. However, prior art clamping structures do not produce precise, predictable clamping loads; and this reduces the precision and predictability of the operating characteristics of the associated damper. Accordingly, there is a need for a piston valve and a method for assembling a piston valve in which the disks are clamped against the valve body with a known force.

### SUMMARY OF THE INVENTION

The present invention is a plate valve, for use in a damper, that can be mass assembled rapidly and which, without requiring close tolerances, provides a predictable and repeatable clamping force holding the disks against the valve body consistently within a desired range in high production quantities. The valve of the present invention includes a valve body, a valve disk, and a spring washer and is preferably retained on the piston end of a damper piston rod. The spring washer has a range of deflection wherein additional forces that are applied to the valve during the assembly process are largely absorbed by the washer, and therefore are not transmitted to the disks. The spring washer thereby “desensitizes” the assembly process, and ensures that the forces with which the disks are clamped against the spring body are relatively consistent for each valve.

In a preferred embodiment, the invention is a valve having a stacked assembly of members including a valve body with an orifice extending therethrough and a valve disk located adjacent the valve body. Central portions, adjacent the inner radial edges, of all the members of the stacked assembly, including the valve body and the valve disk, are retained between first and second stops on a shaft. A clamping spring, preferably a spring washer, is provided in series with the members of the stacked assembly to define a load path retaining all members of the stacked assembly on the shaft. The orifice is in a radially outer part of the valve body; and a radially outer part of the valve disk that covers the orifice is free, when the valve assembly is immersed in fluid and fluid is forced through the compression orifice, to be urged away from the orifice by pressure of the fluid.

One embodiment is shown in which the shaft is an integral extension of the piston, with the stops being a stepped diameter of the piston rod and a riveted end of the piston. Another embodiment is shown in which the shaft is a rivet and a member of the stacked assembly, for example the valve body, is retained in a piston on the piston rod.

### SUMMARY OF THE DRAWINGS

FIG. 1 is a partial side elevation in section of a vehicle damper incorporating a first embodiment of the valve of the present invention;

FIG. 2 is a detail in section of the valve of the damper of FIG. 1;

FIG. 3 is an exploded view, partially in section, of the valve of FIG. 2;

FIG. 4 is a top plan view of the valve body of the valve of FIG. 2;

FIG. 5 is a section along line 5-5 of FIGS. 4 and 6;

FIG. 6 is a bottom plan view of the valve body of FIG. 2;

FIG. 7 is a detail in section of the valve of FIG. 2, mounted in an assembly fixture, showing the spring washer in an uncompressed state; and

FIG. 8 is the detail of FIG. 7, but showing the spring washer in a compressed state.

FIG. 9 is a schematic, cross-sectional view of a portion of a second embodiment of the invention including a damper piston assembly;

FIG. 10 is a top planar view of the rivet disk of the damper piston assembly of FIG. 9; and

FIG. 11 is a sectional view of the rivet disk of FIG. 10 taken along lines 11-11 of FIG. 10.

### DESCRIPTION OF THE PREFERRED EMBODIMENT

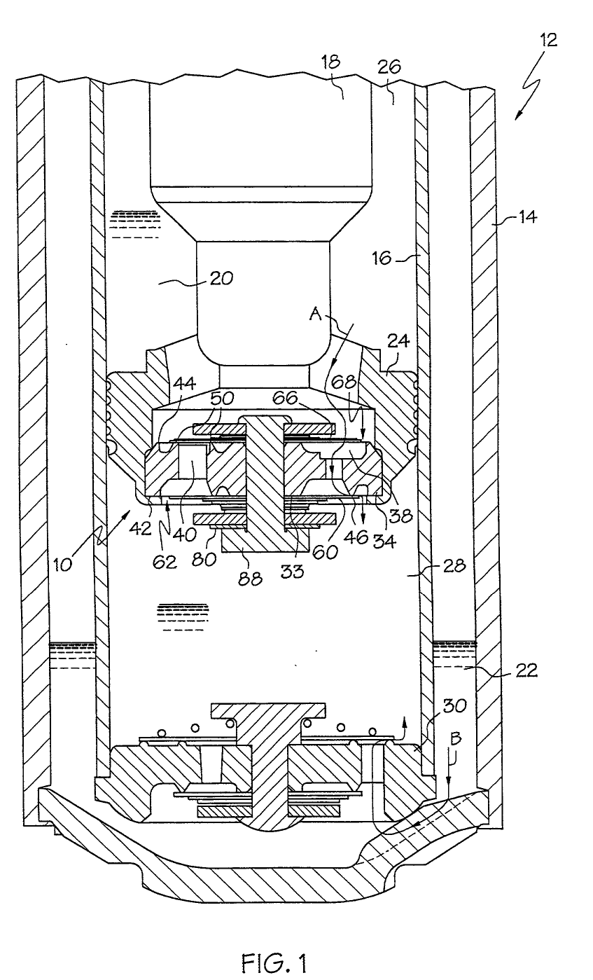

As shown in FIG. 1, a preferred embodiment of the valve of the present invention, generally designated 10, is used in conjunction with a damper, such as a strut 12. However, it should be understood that the valve 10 of the present invention may be used with a variety of dampers, including shocks, struts and other dampers beyond the strut 12 illustrated herein, as well as a variety of other applications beyond dampers. The strut 12 of FIG. 1 includes an outer tube 14, an inner tube 16, and a rod 18 located within the inner tube. The inner tube 16 is filled with a damping fluid 20, and a reservoir 22 is located between the outer tube 14 and the inner tube 16 to receive excess fluid 20.

The rod 18 includes a piston 24 that sealingly engages the inner surface of the inner tube 16. The piston 24 divides the inner tube 16 into an upper chamber 26 and a lower chamber 28. The strut 12 also includes a base valve 30 mounted on the bottom of the inner tube 16 which controls the flow of fluid between the bottom chamber 28 and the reservoir 22. The lower end of the outer tube 14 is mounted on a vehicle wheel support (not shown) and the upper end of the rod 18 (not shown) is connected to the body of the vehicle (not shown). The inner tube 16 and outer tube 14 are connected. Accordingly, the outer and inner tubes 14, 16 move axially in unison relative to the rod 18 when the wheel support is subjected to a shock load.

For example, in the orientation shown in FIG. 1, if the outer tube 14 is moved downwardly, the rod 18 and piston 24 move upwardly relative the inner tube 16 (i.e. in the rebound direction). As the piston 24 moves upwardly, fluid 20 is urged from the upper chamber 26 to the lower chamber 28 via the valve 10. This path of fluid through the valve is indicated by arrows A. As the piston 24 moves upwardly, fluid also flows from the reservoir 22 to the lower chamber 28 via the base valve 30 (shown by arrows B). Similarly, when the rod 18 moves downwardly relative the inner tube 16 (i.e. in the compression direction), fluid 20 flows from the lower chamber 28 to the upper chamber 26 via the valve 10, and flows from the lower chamber 28 to the reservoir 22 via the base plate valve 30.

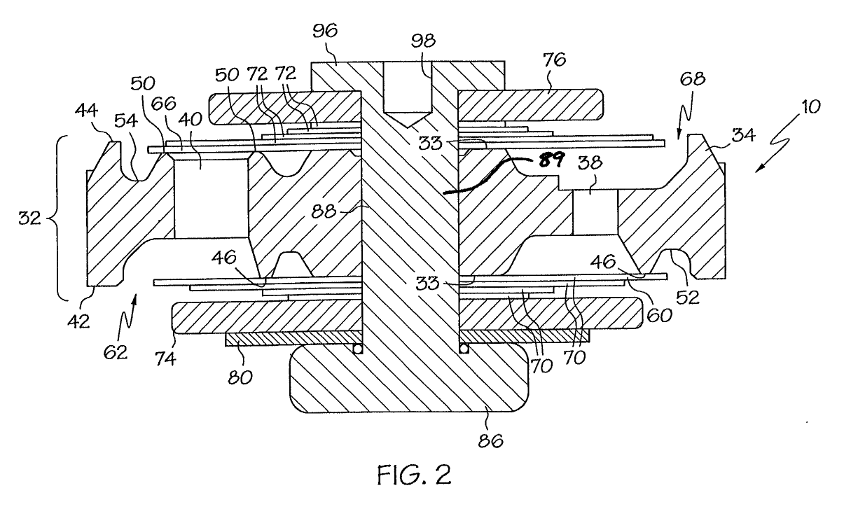

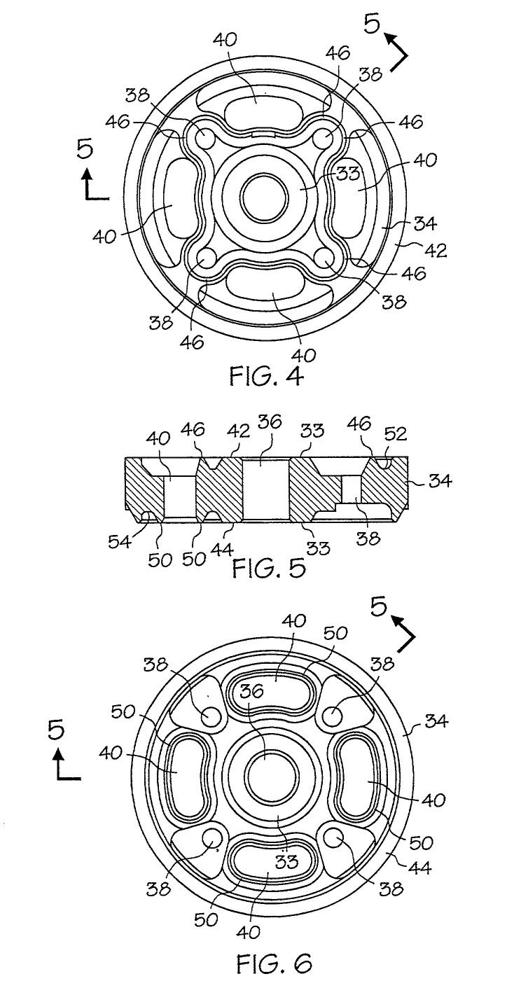

The valve 10 controls the flow of fluid 20 within the inner tube 16, and is shown in greater detail in FIGS. 2-6. As shown in FIG. 2, the valve 10 includes a valve assembly 32 having a generally cylindrical valve body 34. As best shown in FIGS. 4-6, the valve body 34 has a central hole 36, a set of rebound orifices 38 and a set of compression orifices 40 extending through the body 34. The valve body 34 has a first or inner surface 42 and a second or outer surface 44, and includes a rebound ridge 46, or raised surface, extending around the rebound orifices 38 on the first surface 42 of the valve body. The rebound orifices 38 are located inside the rebound ridge 46, which extends around the first surface 42 of the valve body 34 to form a closed loop.

The valve body 34 also includes a plurality of compression ridges 50, each compression ridge extending around the perimeter of an associated compression orifice 40 on the second surface 44 of the valve body. A central ridge or hub 33 is located about the perimeter of the central hole 36 on both surfaces of the valve body 34. As shown in FIG. 5, the valve body 34 includes a first recessed surface 52 located adjacent each rebound orifice 38 on the first surface 42 of the valve body, and a second recessed surface 54 located adjacent the compression orifice on the second surface 44 of the valve body 34.

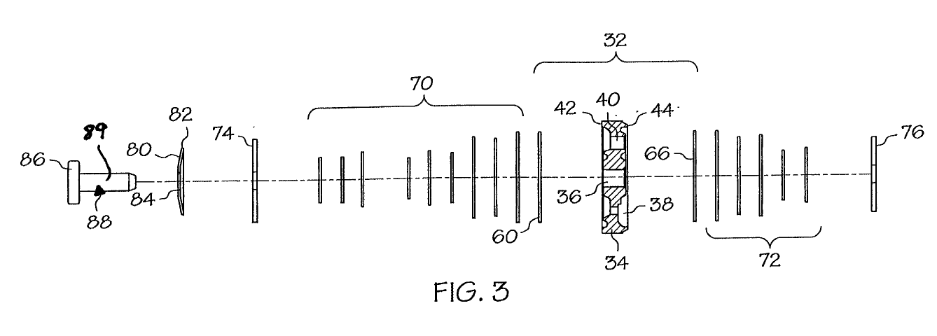

Returning to FIGS. 2 and 3, the valve assembly 32 includes a rebound disk 60 located on the first surface 42 of the valve body 34. The rebound disk 60 engages the rebound ridge 46 and thereby generally seals, or blocks, the rebound orifices 38 on the first surface 42 of the valve body 34. The rebound disk 60 substantially covers the compression orifices 40 located on the first surface 42 of the body but does not completely cover the compression orifices, leaving a gap 62 through which fluid may flow. The valve assembly 32 further includes a compression disk 66 located on the second surface 44 of the valve body 34. The compression disk 66 covers the compression orifices 40 on the second surface 44 of the valve body, and engages the compression ridges 50 to generally seal or block the compression orifices. The compression disk 66 substantially, but not completely, covers the rebound orifices 38 on the second surface 44 of the valve body 34, leaving a gap 68 through which fluid may flow. The rebound disk 60 and compression disk 66 may be the same size and shape, and materials, and therefore may be interchangeable parts.

The rebound ridge 46 may include a series of small slots, or “coins” (not shown) formed in the ridge 46. The slots provide a fluid flow path such that a small amount of fluid can flow past the ridges 46 even when the rebound disk 60 engages the rebound ridge 46. Thus, although the rebound disk 60 generally seals, or block the flow of fluid through, the rebound orifices 38 when the rebound disk is seated against the rebound ridge 46, a small amount of fluid may flow through the rebound orifices via the slots. Similarly, each compression ridges 50 preferably has a series of slots to enable low levels of fluid to flow through the compression orifices 40 when the compression disk 66 is seated against the compression ridges.

A series of stiffening disks 70, 72 may be located on top of the rebound 60 and compression 66 disks, respectively. The diameter, thickness, and number of disks 70, 72 may be selected to control the operating characteristics of the valve 10. For example, an increased number of disks 70, 72 and/or increased thickness of the disks increases the cracking pressure of the associated rebound/compression disk 60, 66 (i.e. increases the pressure required to move the rebound/compression disk away from the rebound/compression ridges). A rebound retainer 74 and a compression retainer 76 are located on top of the disks 60, 66, 70, 72, and a spring washer 80 (also known as a belleville washer) is located on top of one of the retainers 74, 76. The spring washer 80 is preferably generally circular in top view, and has an outer diameter 82 and an inner diameter 84 (FIG. 3). The spring washer 80 is preferably tapered such that the outer diameter 82 is axially spaced from the inner diameter 84. In a preferred embodiment, the spring washer 80 is made of 1070 hardened, tempered steel, although the spring washer may be made from a variety of materials. Various other spring elements, including but not limited to coil springs, wave springs, slotted belleville washers and other components may be used without departing from the scope of the present invention.

Compression disk 66 has an inner or central portion and an outer portion, on the inside and outside, respectively, of the outer periphery of the disk 72 having the smallest radius, that is the one immediately adjacent retainer 74. Rebound disk 60 likewise has an inner or central portion and an outer portion, on the inside and outside, respectively, of the outer periphery of the disk 70 having the smallest radius, that is the one immediately adjacent retainer 76. For both of disks 66 and 60, the inner portion is prevented from flexing due to being clamped between hub 33 of valve body 34 on one side and the stiffening disks on the other side. But the outer portion of each of disks 66 and 60 is free to flex in response to fluid pressure in the appropriate direction, along with portions of the associated stiffening disks also outside the respective periphery.

As shown in FIG. 2, the spring washer 80 is located between the head 86 of a fastener 88 and the rebound retainer 74. However, the spring washer 80 may also be located adjacent the compression disk 66, the retainers 74, 76, the rebound disk 60, or any of the stiffening disks 70, 72. The fastener 88, such as a rivet, extends through the spring washer 80, retainers 74, 76, disks 60, 66, 70, 72 and valve body 34 to hold the valve 10 together.

It can be seen in FIG. 2 that each of the compression disk 66 and rebound disk 60 may be considered to be divided radially between a central, non-flexing portion and an outer, flexing portion. For example, the outer portion of compression disk 66 radially outside the periphery of the stiffening disk 72 immediately adjacent retainer 76 is free to flex upwardly in response to fluid pressure produced by downward movement of the piston in damper compression, with the portions of the remaining stiffening disks 72 outside the same periphery flexing upwardly with it. But the central portions of compression disk 66 and all stiffening disks 72 radially within this periphery are prevented from so flexing by being axially clamped between the head and flare portion of rivet 86. These portions, together with the central hub 33 of valve body 34, make up a central annular core of elements, stacked between retainers 74 and 76, through which the axial force of spring 80 is applied. But as shown and described herein, the axial force of spring 80 is not applied as a return spring for the flexing outer portions of either of disks 60 or 66.

Returning to FIG. 1, when the rod 18 is moved in the rebound direction relative the inner tube 16 (upward as shown in FIG. 1), fluid 20 flows through the piston 24, and enters the rebound orifices 38 of the valve body 34. Because the compression disk 66 does not completely cover the opening of the rebound orifices 38 on the second surface 44 of the valve body 34, fluid 20 is free to enter the rebound orifices at the gaps 68 on the second surface of the valve body. Initially, fluid cannot flow through the rebound orifices 38 because the rebound disk 60 generally seals the rebound orifices on the first surface 42 of the valve body 34. The fluid 20 is blocked in a cavity created by the rebound ridge 46, the central ridge 33 on the first surface 42 of the valve body 34 and the rebound disk 60. However, once the pressure of the fluid 20 in the upper chamber 26 reaches a sufficient level relative the pressure in the lower chamber 28, the rebound disk 60 is deflected away from the rebound ridge 46, thereby enabling fluid to flow through the rebound orifices 38.

Fluid will continue to flow through the rebound orifices 38 as the rod 18 is moved relative the inner tube 16 and the outer tube 14. Once the rod 18 stops moving relative the inner tube 16 and the pressure in the lower chamber 28 increases sufficiently relative the pressure in the upper chamber 26, the rebound disk 60 will return to its original position such that the rebound disk engages the rebound ridge 46 and generally seals the rebound orifices 38. When the rebound disk 60 seats against the rebound ridge 46, small amounts of fluid can still flow through the slots (not shown) in the rebound ridge. The enables the piston 24 to continue to move in the rebound direction a small distance, and the slots provide low speed control to the movement of the piston 24. When the rod 18 is moved in the rebound direction relative the inner tube 16, the fluid 20 presses the compression disk 66 against the compression ridges 50, thereby generally blocking off the compression orifices 38.

When the rod 18 is moved in the compression direction (i.e., downwardly in FIG. 1), fluid 20 will enter the compression orifices 40 at the gap 62 adjacent the rebound disk 60. Once the fluid in the lower chamber 28 reaches a sufficient pressure relative the pressure in the upper chamber 26, the compression disk 66 will be urged away from the compression ridges 50, thereby allowing fluid to flow through the compression orifices 40. When the rod 18 stops moving relative the inner tube 16, the compression disk 66 will return to its original position against the compression ridges 50, thereby generally sealing the compression orifices 40. As noted above, the slots (not shown) in the compression ridges 50 provide low speed control for any continued movement of the rod 18. The rebound orifices 38 remain generally sealed by the rebound disk 60 when the rod 18 is moved in the compression direction.

The size and shape of the rebound orifices 38 and compression orifices 40 may be selected to control the operating characteristics of the valve 10, and thereby the damper 12. In particular, the size and shape of the rebound orifices 38 largely determine the performance of the damper 12 in rebound. The size and shape of the compression orifices 40, in combination with the operating characteristics of the base valve 30, largely determine the performance of the damper 12 in compression. Of course, the size and shape of the disks 60, 66, 70 and 72 also affect the damping characteristics of the valve 10.

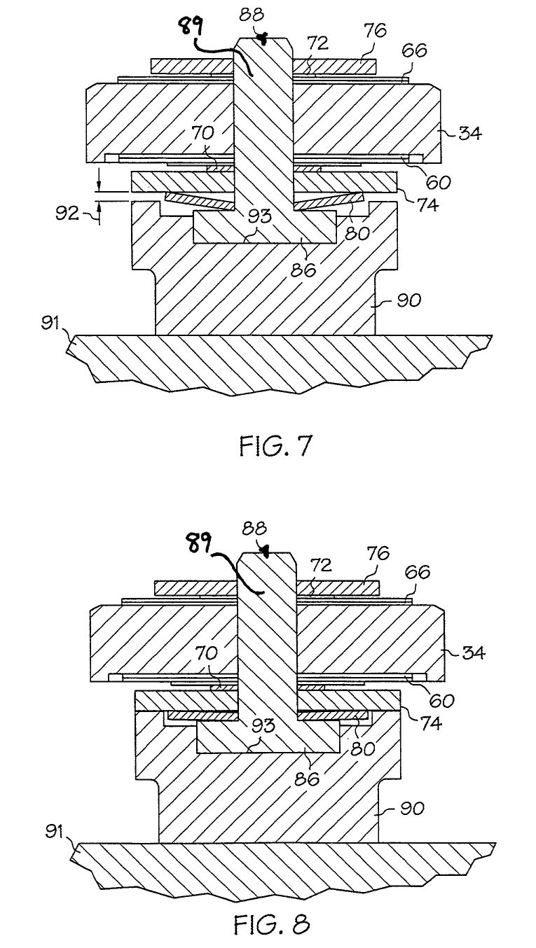

In order to assemble the valve 10, a fastener 88, such as a rivet, is then passed through the spring washer 80, retainers 74, 76, disks 60, 66, 70, 72 and valve body 34. The valve assembly may then be mounted into a fixture 90, as shown in FIG. 7 (the internal details of the valve body 34 being omitted in FIGS. 7 and 8). The fixture 90 is located on top of a support surface 91. The head 86 of the fastener 88 is received in stepped notch 93 in the fixture 90 such that a gap 92 is formed between the fixture 90 and the rebound retainer 74. A compression force (i.e. a force directly downward in FIG. 7) is then applied to the compression retainer 76, which transmits the compression force to the rebound retainer 74. The rebound retainer 74 transmits the force to the spring washer 80, which is then compressed, as shown in FIG. 8. The spring washer 80 is compressed until the gap 92 between the fixture and the rebound retainer 74 is closed. After the gap 92 is closed, the rivet 86 is peened to form a flare portion 96 (FIG. 2) to hold the valve 10 together. The rivet 88 preferably has a hollow tip 98 to reduce the forces required to peen the rivet 88. The hollow tip 98 also helps to ensure that the rivet 88 flares out properly when peening forces are applied, which reduces the chances that the rivet 88 may bulge in the middle section of the shank of the rivet. Of course, rivets not having a hollowing tip may also be used. Other method of fastening, including but not limited to bolts, clamps, and welds may be used without departing from the scope of the invention.

The height of the gap 92 controls the compression of the spring washer 80 and therefore the force with which the disks 60, 66 are pressed against the valve body. The gap 92 is determined by the dimensions of the washer 80, the head of the rivet 86, and the stepped notch 93 in the fixture 90. Although it is desired to maintain uniform spacing of the gap 92 and therefore provide uniform compression of the washer 80, there may be variations in the dimensions of the washer 80 and the head of the rivet 86. Thus, the spring washer 80 of the valve 10 of the present invention can account for, and lessen the effects of, any variations in the gap 92.

As the spring washer 80 is compressed, the disks 60, 66 are pressed against the valve body 34. It is desired to press the disks 60, 66 against the valve body 34 with a known force. The spring washer 80 accommodates or “takes up” a significant portion of the forces applied to the valve 10 during assembly and thereby desensitizes the assembly process. As the valve 10 is compressed during assembly, the spring washer 80 tends to flatten out against the retainer 74, and this motion accommodates a portion of the compression force. The spring “constant” of the spring washer 80 is not linear with respect to the applied force, but tends to level out at higher forces. Thus, for example, when the spring washer 80 is nearly compressed flat against the retainer 74, any additional forces that are applied to the compression retainer 76 (and therefore the valve 10) during assembly will be transmitted into forces that tend to further flatten the spring washer 80, and the forces are not transmitted to the rest of the valve 10. In the present embodiment, when the spring washer 80 is in the state of being between about ⅔ and ¾ fully compressed, any additional compression forces applied to the valve 10 during assembly are largely taken up by the spring washer 80. Thus, the fixture 90 is preferably configured such that the gap 92 is of a size such that the spring washer is compressed, for example, about 17/24 towards full compression (i.e., midway between ⅔ and ¾). Any variations in the compression of the spring washer 80 (i.e., slightly above or slightly below the targeted compression force) will largely be taken up by the spring washer and will not be transmitted to the valve 10. This ensures that the compression disk 66 and rebound disk 60 are pressed against their respective ridges with a relatively repeatable, consistent force. The spring washer 80 also has a low profile, and does not significantly add to the size or cost of the valve 10.

The central ridge 33 is preferably the same height as, or flush with, the rebound ridge 46 such that the rebound disk 60 sits flat against the rebound ridge 46 and the central ridge 33. Furthermore, the central ridge 33 is preferably about the same height as the compression ridges 50. However, during manufacturing the tolerances of the rebound ridge 47, compression ridges 50 and central ridge 33 may not be able to be precisely controlled. Thus, the rebound ridge 47 and compression ridges 50 may be made slightly shorter than the central ridge 33. It is desirable to have the rebound ridge 47 and compression ridges 50 slightly shorter, as opposed to slightly taller, than the central ridge 33 to avoid preloading the rebound disk 60 and compression disk 66.

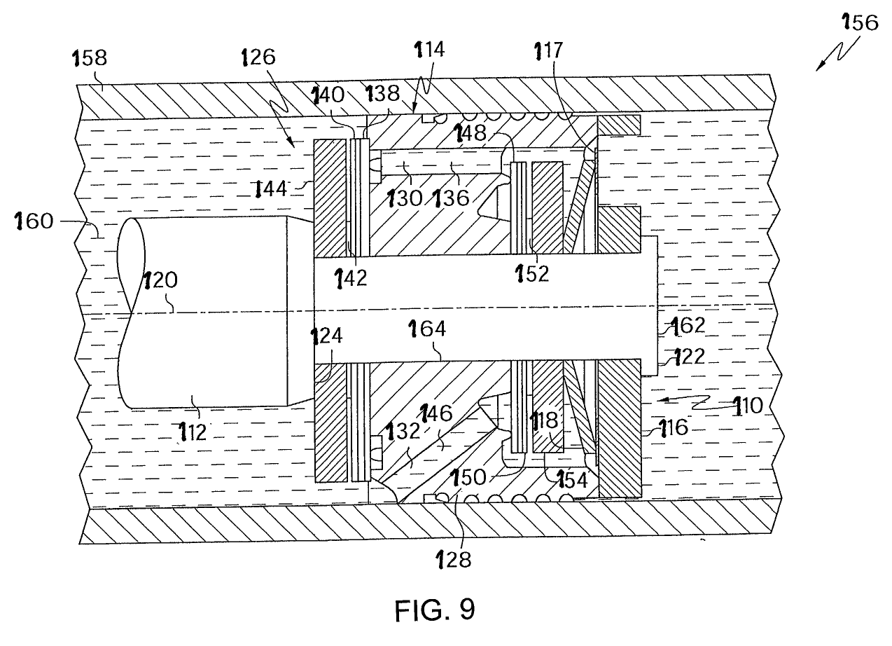

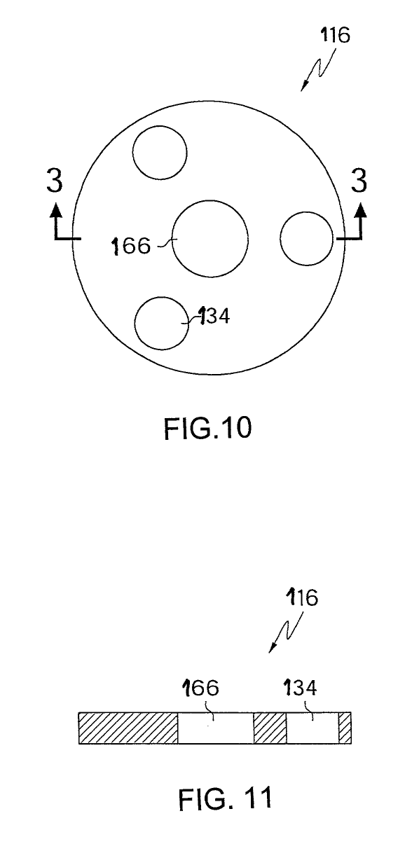

FIGS. 9 through 11 illustrate a second embodiment of the present invention. In a first expression of the second embodiment shown in the figures, a damper piston assembly 10 includes a rod 112, a piston 114, a rivet disk 116, and a spring 118. The rod 112 has a longitudinal axis 120, a riveted end 122, and a longitudinal stop 124. The piston 114 surrounds the rod 112 between the riveted end 122 and the longitudinal stop 124. The piston 114 includes a valve assembly 126 having a valve body 128 with an orifice 130 or 132 extending therethrough. It is noted that two orifices 130 and 132 are shown in FIG. 9, but that the valve body 128 can have a single orifice, two orifices, or more than two orifices, as can be appreciated by the artisan. The rivet disk 116 surrounds the rod 112 and has an opening 134 for fluid communication with the orifice 130 or 132. The rivet disk 116 is longitudinally secured between the piston 114 and the riveted end 122 of the rod 112. The spring 118 is disposed in compression longitudinally between the rivet disk 16 and the longitudinal stop 124 of the rod 112. A spring 118 disposed in compression means a spring 18 disposed at least partially in compression.

In one construction of the first expression, the rod 112 is a monolithic rod. In other constructions, not shown, the rod includes two or more pieces which are attached together to form the overall rod.

In one design of the first expression, the rivet disk 16 directly contacts the riveted end 122 of the rod 112. In the same or a different design, the rivet disk 116 directly contacts the piston 114. In the same or a different design, the spring 118 directly contacts the rivet disk 116. In other designs, not shown, an intervening part or parts may be disposed between the rivet disk and the riveted end of the rod, the rivet disk and the piston, and the spring and the rivet disk, as can be appreciated by the artisan. In one example, a shim disk 17 is disposed between the spring and the rivet disk.

In one model of the first expression, the spring 118 consists essentially of a Belleville washer. In other models, not shown, the spring includes any apparatus or composition which exerts a spring force when compressed such as, without limitation, a coil spring, a leaf spring, an elastomeric material, and/or a magnetic force spring, etc.

In one depiction of the first expression, the rod 112 is substantially a right-circular cylindrical rod having a larger diameter from the longitudinal stop 124 longitudinally away from the riveted end 122 and having a smaller diameter from the longitudinal stop 124 toward the riveted end 122. In other depictions, not shown, the longitudinal stop is a flange monolithically, directly, or indirectly affixed to the rod. In other depictions, the longitudinal stop is a flange member mounted on the rod and longitudinally disposed against a shoulder of the rod. Still other depictions are left to the artisan.

In one arrangement of the first expression, the orifice 130 is a compression orifice 136, wherein the valve assembly 126 further includes a compression disk 138 located adjacent the valve body 128 and covering the compression orifice 136, and wherein, when the valve assembly 126 is immersed in fluid, fluid can be forced through the compression orifice 136 when the pressure of the fluid urges the compression disk 138 away from the compression orifice 136. It is noted that in one modification to improve piston performance, not shown, the valve assembly 126 provides for fluid leakage even when the compression disk 138 covers the compression orifice 136, as can be appreciated by those skilled in the art. In one variation, the valve assembly 126 includes (starting from the compression disk 138 and longitudinally moving to the longitudinal stop 124) stiffening disks 140, a spacer disk 142, and a compression retainer 144. In one construction, not shown, the compression retainer is monolithically or directly attached to the rod so as to define the longitudinal stop of the rod.

In the same or another arrangement of the first expression, the orifice 132 is a rebound orifice 146 wherein the valve assembly 126 further includes a rebound disk 148 located adjacent the valve body 128 and covering the rebound orifice 146, and wherein, when the valve assembly 126 is immersed in fluid, fluid can be forced through the rebound orifice 146 when the pressure of the fluid urges the rebound disk 148 away from the rebound orifice 146. It is noted that in one modification to improve piston performance, not shown, the valve assembly 126 provides for fluid leakage even when the rebound disk 148 covers the rebound orifice 146, as can be appreciated by those skilled in the art. In one variation, the valve assembly 126 includes (starting from the rebound disk 148 and longitudinally moving toward the rivet disk 116) stiffening disks 150, a spacer disk 152, and a rebound retainer 154, and the spring 118 is disposed longitudinally between the rebound retainer 154 and the rivet disk 116. In another variation, not shown, the spring is disposed longitudinally between any two damper piston assembly elements between the rebound retainer and the rebound disk or any two damper piston assembly elements between the compression disk and the longitudinal stop.

In a second expression of the second embodiment shown in the figures, a damper 156 includes a tube 158 and a damper piston assembly 110. The tube 158 contains a damping fluid 160. An example of a damping fluid includes, without limitation, oil. The damper piston assembly 110 includes a rod 112, a piston 114, a rivet disk 116, and a spring 118. The rod 112 has a longitudinal axis 120, a riveted end 122, and a longitudinal stop 124. The piston 114 is disposed within, and is slidingly engageable with, the tube 158. The piston 114 surrounds the rod 112 between the riveted end 122 and the longitudinal stop 124. The piston 114 includes a valve assembly 126 having a valve body 128 with an orifice 130 or 132 extending therethrough. It is noted that two orifices 130 and 132 are shown in FIG. 9, but that the valve body 128 can have a single orifice, two orifices, or more than two orifices, as can be appreciated by the artisan. The rivet disk 116 surrounds the rod 112 and has an opening 134 for fluid communication with the orifice 130 or 132. The rivet disk 116 is longitudinally secured between the piston 114 and the riveted end 122 of the rod 112. The spring 118 is disposed in compression longitudinally between the rivet disk 116 and the longitudinal stop 124 of the rod 112. It is noted that the previously described constructions, designs, examples, models, depictions, arrangements, modifications, and variations of the first expression are equally applicable to the second expression of the second embodiment shown in the figures.

An application of the damper 156 is its use as a shock absorber for an automobile, an airplane, or other type of vehicle. Another application is use of the damper 156 to provide motion resistance on exercise equipment such as stair climbers and rowing machines. A further application is use of the damper 156 to provide motion isolation for a building, bridge, or other structure subject to earthquakes. An additional application is use of the damper 144 to dampen vibrations encountered by vehicles and structures in outer space. Other applications are left to the artisan. It is noted that the damper 156 (and the damper piston assembly 110) can be adapted or configured to include magnetorheological or other exotic types of damping known or to be invented.

A first method of the invention is for making a damper piston assembly 110 and includes steps a) through h). Step a) includes providing a rod 112 having a longitudinal axis 120, a first end 162, and a longitudinal stop 124. Step b) includes providing a piston 114 including a valve assembly 126 having a valve body 128 with an orifice 130 or 132 extending therethrough and with a mounting hole 164 extending therethrough. Step c) includes mounting the piston 114 on the rod 112 with the first end 162 of the rod 112 extending through the mounting hole 164 of the valve body 128. Step d) includes mounting a spring 118 on the rod 112. Step e) includes providing a rivet disk 116 having a mounting hole 166 extending therethrough and having an opening 134 extending therethrough for fluid communication with the orifice 130 or 132. Step f) includes mounting the rivet disk 116 on the rod 112 after mounting the piston 114 and the spring 118 on the rod 112. Step g) includes longitudinally moving the rivet disk 116 against the piston 114 compressing the spring 118 with the first end 162 of the rod 112 extending through the mounting hole 166 of the rivet disk 116. Compressing the spring 118 means at least partially compressing the spring 118. Step h) includes, after step g), peening the first end 162 of the rod 112 against the rivet disk 116 to define a riveted end 122 of the rod 112. In one example, the first end 162 has a hole (not shown) to help form the riveted end 122 in step h).

In one implementation of the first method, the spring 118 consists essentially of a Belleville washer, and step d) is performed after step c). In the same or another implementation of the first method, the rod 112 of step a) is substantially a right-circular cylindrical rod having a larger diameter from the longitudinal stop 124 longitudinally away from the riveted end 122 and having a smaller diameter from the longitudinal stop 124 toward the riveted end 122. In the same or another implementation of the first method, the orifice 130 of step b) is a compression orifice 136, wherein the valve assembly 126 of step b) further includes a compression disk 138 located adjacent the valve body 128 and covering the compression orifice 136, and wherein, when the valve assembly 126 is immersed in fluid, fluid can be forced through the compression orifice 136 when the pressure of the fluid urges the compression disk 138 away from the compression orifice 136.

In the same or another implementation of the first method, the orifice 132 of step b) is a rebound orifice 146, wherein the valve assembly 126 of step b) further includes a rebound disk 148 located adjacent the valve body 128 and covering the rebound orifice 146, and wherein, when the valve assembly 126 is immersed in fluid, fluid can be forced through the rebound orifice 146 when the pressure of the fluid urges the rebound disk 148 away from the rebound orifice 146.

In the same or another implementation of the first method, step d) is performed after step c), the spring 118 (such as the transversely outer portion of a Belleville spring) in a relaxed state extends beyond the piston 114. In this implementation, the method also includes the step of measuring, after step d) and before step f), the force required to compress the spring 118 flush with the piston 114. In this implementation, the method then includes, before step f), the step of mounting a shim disk 17, as needed, on the rod 112, wherein the thickness of the shim disk is chosen so that, after step h), the spring 118 exerts a predetermined force. In one variation, the valve assembly 126 also includes an orifice disk (e.g., the compression disk 138 or the rebound disk 148) located adjacent the valve body 128 and covering the orifice (e.g., the associated compression orifice 136 or rebound orifice 146), and wherein after step h), the orifice disk experiences the predetermined force of the spring 118. By starting with a spring having a lower than desired installed spring force, this implementation uses a shim disk of appropriate thickness to achieve the desired installed spring force. This compensates for dimensional variations between valve assemblies allowing damper piston assemblies to be made having a consistent desired clamping force on each valve assembly.

Several benefits and advantages are derived from the invention. The spring and rivet attachment of the piston (including the valve assembly) to the rod provides a secure attachment with a lower clamp load on the piston (including the valve assembly). A lower clamp load on the valve assembly means less damage to valve components and especially to orifice disks (for those valve assemblies having orifice disks). In one example, the clamp load is generally 250 pounds. The spring and rivet attachment also provides a more precise and repeatable clamp load on the piston (including the valve assembly) regardless of the manufacturing tolerances of the individual components, especially in the example when a shim disk is employed. Having an exact and repeatable clamp load for each manufactured damper piston assembly provides for optimal valve operation (such as optimal orifice disk operation for those valve assemblies having orifice disks). The spring and rivet attachment reduces costs by eliminating the threaded rod of conventional piston assemblies employing threaded rods and simplifies and reduces the costs of assembly equipment compared to conventional weld and crimp or conventional threaded-nut assembly equipment.

1. A valve assembly for a fluid damper comprising:
a shaft having first and second stops fixed thereon in axially spaced positions;
a stacked assembly comprising a plurality of members having central portions adjacent and surrounding the shaft and retained axially between the first and second stops, one of the plurality of members comprising a valve body having an outer portion radially outside its central portion, the outer portion of the valve body having an orifice extending therethrough between axial surfaces thereof, another of the plurality of members comprising a flexible valve disk located adjacent the valve body and having an outer portion radially outside its central portion and covering the orifice, the valve body and the flexible valve disk being held in close engagement such that, when said piston assembly is immersed in fluid, fluid can be forced through the orifice when the pressure of the fluid urges the outer portion of the valve disk away from the orifice; and
a stack retention spring surrounding the shaft and exerting an axially compressive force through a clamping load path comprising the portion immediately adjacent the radially inner edge of every one of the plurality of members in series between the first stop and the second stop to retain all members of the stacked assembly on the shaft between the first and second stops.

2. A valve assembly according to claim 1 incorporated in a damper piston.

3. A valve assembly according to claim 2 in which the compression spring is a spring washer.

4. A valve assembly according to claim 3 in which the compression spring is a Belleville washer.

5. The valve assembly of claim 3 wherein said spring washer is held in a state of compression by said fastener such that any additional force applied to said spring washer by said fastener are largely accommodated by said spring washer and not transmitted to said valve assembly.

6. A valve assembly according to claim 2 in which the orifice is a rebound orifice and the valve is a rebound valve.

7. A valve assembly according to claim 2 in which the orifice is a compression orifice and the valve is a compression valve.

8. The valve assembly of claim 2 wherein the shaft is an integral extension of a damper piston rod.

9. The valve assembly of claim 8 wherein the first stop comprises a stepped diameter formed in the damper piston rod and the second stop comprises a riveted end of the integral extension of the damper piston rod.

10. The valve assembly of claim 2 wherein the shaft comprises a rivet and the stack of elements is retained in a damper piston.

11. The valve assembly of claim 10 wherein the valve body is retained in the damper piston.

12. The valve assembly of claim 1 wherein the stack of valve elements further comprises a first stack retainer at one axial end thereof and a second stack retainer at the opposite axial end thereof, the spring being disposed between one of the first and second stack retainers and one of the first and second stops.

13. The valve assembly of claim 2 wherein the stack of valve elements further comprises a first stack retainer at one axial end thereof and a second stack retainer at the opposite axial end thereof, the spring being disposed between one of the first and second stack retainers and one of the first and second stops.

14. A valve assembly for a fluid damper comprising:
a shaft having first and second stops fixed thereon in axially spaced positions;
a stacked assembly comprising a plurality of members having central portions adjacent and surrounding the shaft and retained axially between the first and second stops, one of the plurality of members comprising a valve body having an outer portion radially outside its central portion, the outer portion of the valve body having an orifice extending therethrough between axial surfaces thereof, another of the plurality of members comprising a flexible valve disk located adjacent the valve body and having an outer portion radially outside its central portion and covering the orifice, the valve body and the flexible valve disk being held in close engagement such that, when said piston assembly is immersed in fluid, fluid can be forced through the orifice when the pressure of the fluid urges the outer portion of the valve disk away from the orifice; and
a stack retention spring surrounding the shaft and exerting an axially compressive force through a load path comprising the central portions of all of the plurality of members in series between the first stop and the second stop to retain all members of the stacked assembly on the shaft between the first and second stops, the stacked piston assembly defining no continuous clamping load path between the first stop and the second stop that does not include the stack retention spring.

15. A valve assembly according to claim 14 incorporated in a damper piston.

16. A valve assembly according to claim 15 in which the compression spring is a spring washer.

17. A valve assembly according to claim 16 in which the compression spring is a Belleville washer.

18. The valve assembly of claim 16 wherein said spring washer is held in a state of compression by said fastener such that any additional force applied to said spring washer by said fastener are largely accommodated by said spring washer and not transmitted to said valve assembly.

19. A valve assembly according to claim 15 in which the orifice is a rebound orifice and the valve is a rebound valve.

20. A valve assembly according to claim 15 in which the orifice is a compression orifice and the valve is a compression valve.

21. The valve assembly of claim 15 wherein the shaft is an integral extension of a damper piston rod.

22. The valve assembly of claim 21 wherein the first stop comprises a stepped diameter formed in the damper piston rod and the second stop comprises a riveted end of the integral extension of the damper piston rod.

23. The valve assembly of claim 15 wherein the shaft comprises a rivet and the stack of elements is retained in a damper piston.

24. The valve assembly of claim 23 wherein the valve body is retained in the damper piston.

25. The valve assembly of claim 14 wherein the stack of valve elements further comprises a first stack retainer at one axial end thereof and a second stack retainer at the opposite axial end thereof, the spring being disposed between one of the first and second stack retainers and one of the first and second stops.

26. The valve assembly of claim 14 wherein the stack of valve elements further comprises a first stack retainer at one axial end thereof and a second stack retainer at the opposite axial end thereof, the spring being disposed between one of the first and second stack retainers and one of the first and second stops.

27. A valve assembly for a fluid damper comprising:
a) a damper piston rod having a longitudinal axis, a riveted end, and a longitudinal stop;
b) a stacked assembly of piston members surrounding the rod between the riveted end and the longitudinal stop, wherein one of the piston members is a valve assembly having a valve body with an orifice extending therethrough;
c) a rivet disk surrounding the rod and having an opening for fluid communication with the orifice, wherein the rivet disk is a another piston member of the stacked assembly at an end thereof adjacent the riveted end of the rod, the piston members of the stacked assembly defining a central core longitudinally maintained on the rod with an axial clamping force; and
d) a spring disposed in compression longitudinally between the rivet disk and the longitudinal stop of the rod, the spring completely determining the axial clamping force in the stacked assembly of piston members.

28. The valve assembly of claim 27 further comprising a shim disk disposed between the spring and the rivet disk, the shim disk having an axial thickness producing a predetermined axial clamping force in the spring.
